(19) United States
(12) Patent Application Publication
(10) Pub. No.: US 2025/0304774 A1
(43) Pub. Date: Oct. 2, 2025

(54) Molding Material

(71) Applicant: SEIKO EPSON CORPORATION, Tokyo (JP)

(72) Inventors: Tomohiro FUJITA, Matsumoto (JP); Chieko NAKAJIMA, Suwa (JP); Kiyoaki SAKAGUCHI, Suwa (JP); Daisuke IKEDA, Suwa (JP); Makoto YOSHIDA, Matsumoto (JP)

(21) Appl. No.: 19/092,317

(22) Filed: Mar. 27, 2025

(30) Foreign Application Priority Data
Mar. 28, 2024 (JP) 2024-053230
Mar. 28, 2024 (JP) 2024-053380

(51) Int. Cl. C08L 1/02; C08L 67/04

(52) U.S. Cl. CPC C08L 1/02; C08L 67/04

(57) ABSTRACT

A molding material includes a resin, and cellulose, the resin includes a combination of an aliphatic polyester and a polyester-based elastomer, or a combination of polylactic acid and a biodegradable polyester other than the polylactic acid, the cellulose includes a first cellulose having a peak top in a particle diameter region of 3 μm or more and 100 μm or less in a volume-based particle size distribution curve, and a second cellulose having a peak top in a particle diameter region of 50 μm or more and 500 μm or less in a volume-based particle size distribution curve, and a particle diameter of the first cellulose at the peak top is smaller than a particle diameter of the second cellulose at the peak top.

The present application is based on, and claims priority from JP Application Serial Number 2024-053230, filed Mar. 28, 2024 and JP Application Serial Number 2024-053380, filed Mar. 28, 2024, the disclosures of which are hereby incorporated by reference herein in their entirety.

### BACKGROUND

### 1. Technical Field

The present disclosure relates to a molding material.

### 2. Related Art

There is an attempt to improve the strength of a resin-based material by blending cellulose. For example, JP-A-2005-272783 discloses a natural fiber-reinforced polyester material containing an aliphatic polyester (polylactic acid), an elastomer, and pulp.

However, when blending cellulose with a resin, it is necessary to knead both the cellulose and the resin. In such kneading, heat is easily generated, and the resin and the cellulose may be discolored or deteriorated by the heat, and the like. Thus, the color toning properties may be deteriorated.

### SUMMARY

According to an aspect of the present disclosure, there is provided a molding material including:
a resin; and
cellulose, in which
the resin includes an aliphatic polyester and a polyester-based elastomer,
the cellulose includes a first cellulose having a peak top in a particle diameter region of 3 μm or more and 100 μm or less in a volume-based particle size distribution curve, and a second cellulose having a peak top in a particle diameter region of 50 μm or more and 500 μm or less in a volume-based particle size distribution curve, and
a particle diameter of the first cellulose at the peak top is smaller than a particle diameter of the second cellulose at the peak top.

According to another aspect of the present disclosure, there is provided a molding material including:
a biodegradable resin; and
cellulose, in which
the biodegradable resin includes polylactic acid and a biodegradable polyester other than the polylactic acid,
the cellulose includes a first cellulose having a peak top in a particle diameter region of 3 μm or more and 100 μm or less in a volume-based particle size distribution curve, and a second cellulose having a peak top in a particle diameter region of 50 μm or more and 500 μm or less in a volume-based particle size distribution curve, and
a particle diameter of the first cellulose at the peak top is smaller than a particle diameter of the second cellulose at the peak top.

### BRIEF DESCRIPTION OF THE DRAWINGS

FIG. 1 is Table 1 showing the compositions, properties, and evaluation results of molding materials of Examples and Comparative Examples.

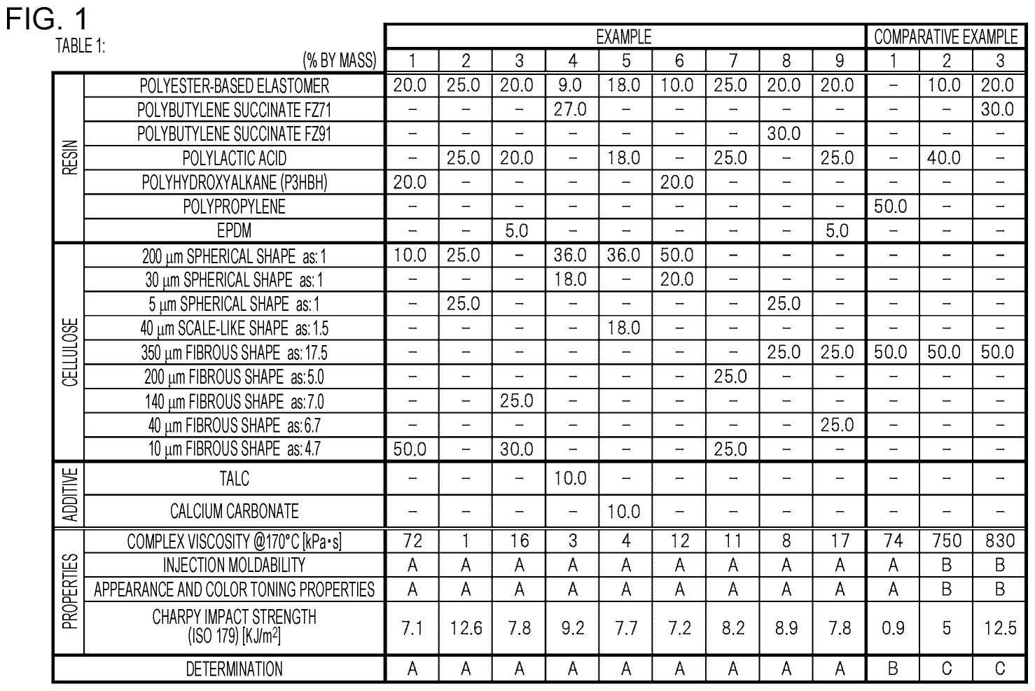

FIG. 2 is Table 2 showing the compositions, properties, and evaluation results of molding materials of Comparative Examples.

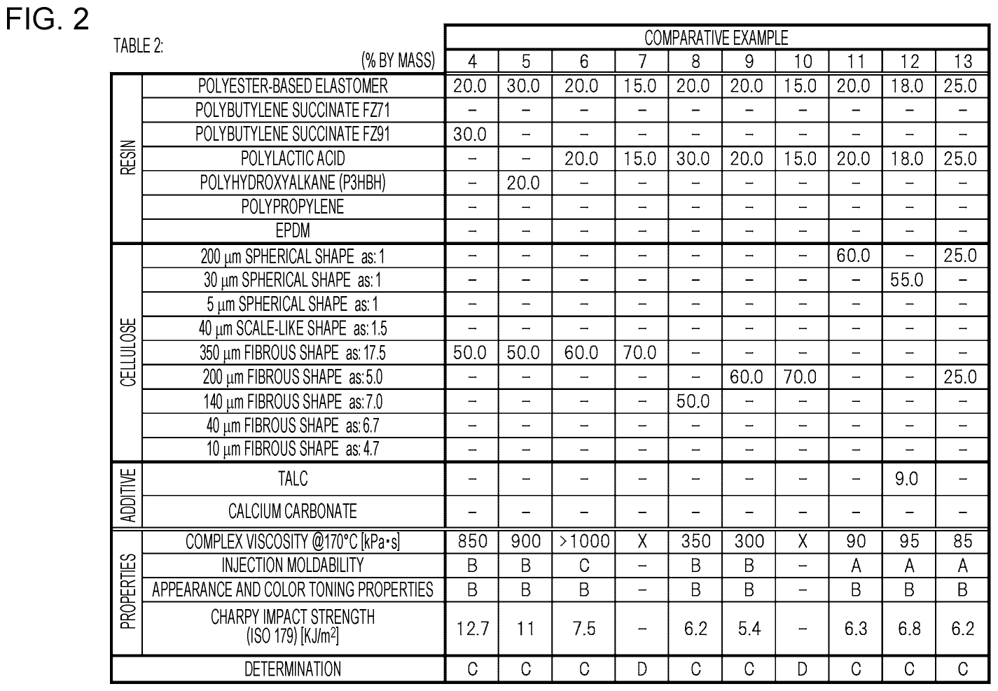

FIG. 3 is Table 3 showing the compositions, properties, and evaluation results of molding materials of Examples and Comparative Examples.

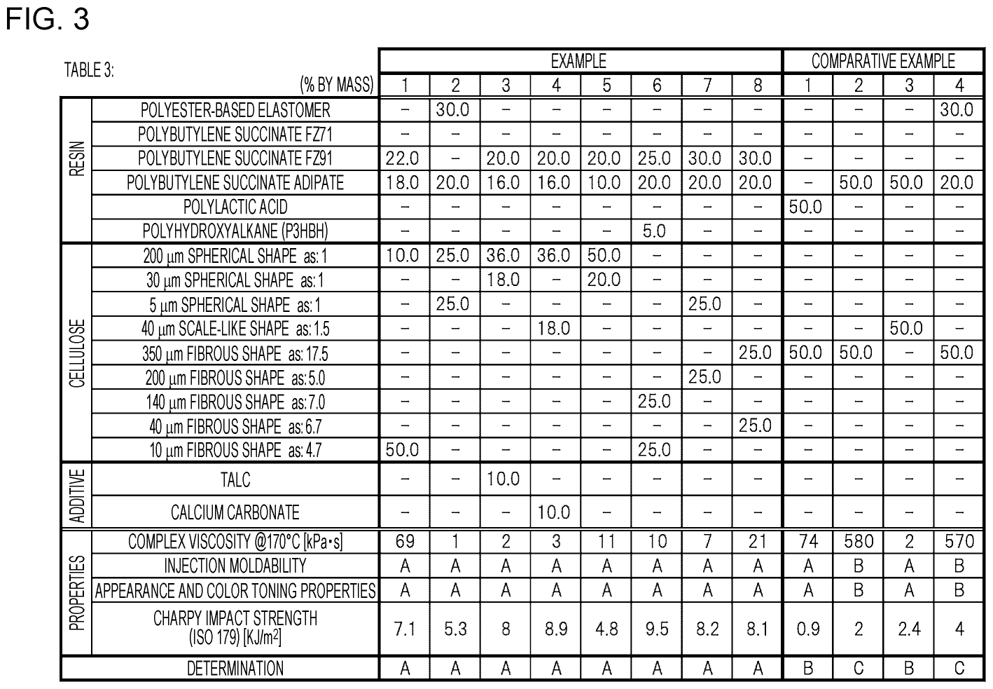

FIG. 4 is Table 4 showing the compositions, properties, and evaluation results of molding materials of Comparative Examples.

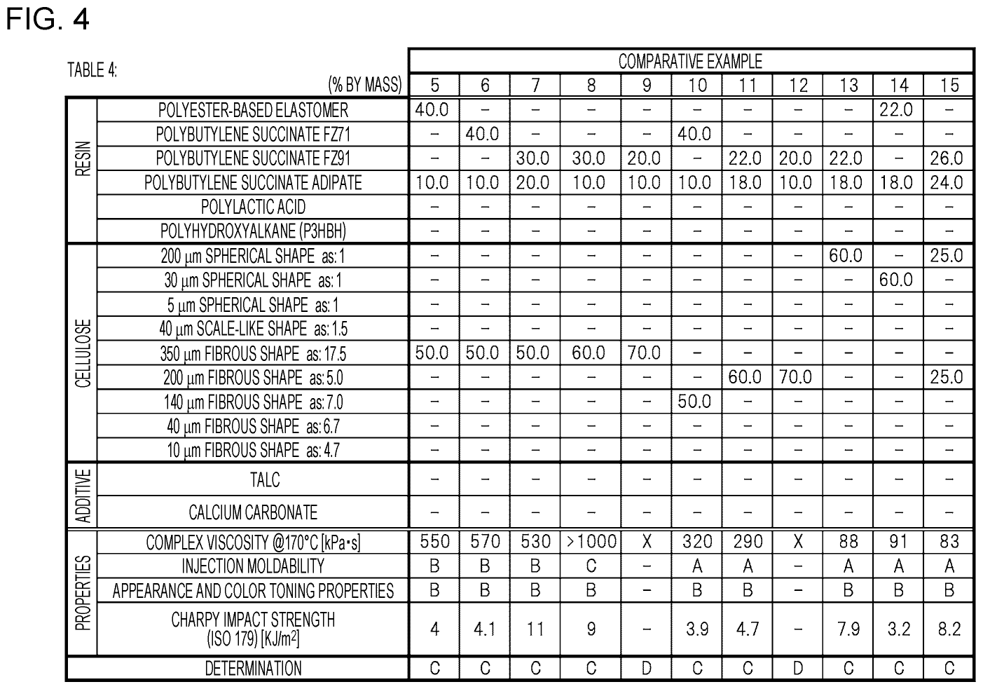

### DESCRIPTION OF EMBODIMENTS

Hereinafter, a first embodiment of the present disclosure will be described. The embodiments described below describe examples of the present disclosure. The present disclosure is not limited to the following embodiments, and includes various modifications implemented within a range not changing a gist of the present disclosure. It should be noted that not all of the configurations described below are essential configurations of the present disclosure.

### 1. Molding Material

A molding material according to the present embodiment includes a resin, and cellulose. The resin includes an aliphatic polyester and a polyester-based elastomer, the cellulose includes a first cellulose having a peak top in a particle diameter region of 3 μm or more and 100 μm or less in a volume-based particle size distribution curve, and a second cellulose having a peak top in a particle diameter region of 50 μm or more and 500 μm or less in a volume-based particle size distribution curve, and a particle diameter of the first cellulose at the peak top is smaller than a particle diameter of the second cellulose at the peak top.

### 1.1. Resin

The molding material of the present embodiment includes a resin. The resin can form a matrix in the molding material. The molding material is a composite material having a structure in which cellulose to be described later is dispersed in the resin.

The resin includes an aliphatic polyester and a polyester-based elastomer. The aliphatic polyester and the polyester-based elastomer have thermoplasticity, and when a molded article is produced from the molding material, the aliphatic polyester and the polyester-based elastomer are melted to bind the cellulose fibers to each other. In addition, the aliphatic polyester and the polyester-based elastomer contribute to the physical properties of the molded article together with the cellulose fibers. Further, the aliphatic polyester and the polyester-based elastomer have a possibility of being produced and used as a bioplastic in the future, and are materials that are expected to promote the reduction of environmental load.

### 1.1.1. Aliphatic Polyester

The aliphatic polyester is a polyester having no aromatic ring, and examples thereof include a polycondensate of an aliphatic hydroxycarboxylic acid, a polycondensate of an aliphatic dicarboxylic acid and an aliphatic diol, a ring-opening polymer of an aliphatic lactone, a plurality of copolymers of these monomers, and transesterification products of these polymers. In addition, the aliphatic polyester may include a structure derived from a monomer that can form three or more ester bonds such as an aliphatic triol or an aliphatic tricarboxylic acid, or a monomer having an alicyclic skeleton.

Examples of such aliphatic polyesters include poly-L-lactic acid (PLLA), poly-D-lactic acid (PDLA), a random copolymer of L-lactic acid and D-lactic acid, polylactic acid such as a stereo complex of L-lactic acid and D-lactic acid, polycaprolactone, polypivalolactone, polyhydroxybutyric acid (P3HB), polyhydroxyvaleric acid, poly(3-hydroxybutyrate-co-3-hydroxyhexanoate), poly(3-hydroxybutyrate-co-3-hydroxyvalerate), polylactic acid-co-polyglycolic acid, polylactic acid-co-polycaprolactone, polyethylene succinate, polypropylene succinate, polybutylene succinate (PBS), polyethylene adipate, polypropylene adipate, polybutylene adipate (PBA), polyneopentylglycol adipate, polyethylene sebacate, polypropylene sebacate, polybutylene sebacate, polyethylene succinate/adipate, polypropylene succinate/adipate, and polybutylene succinate/adipate.

The content of the aliphatic polyester is preferably 1% by mass or more, more preferably 5% by mass or more, still more preferably 10% by mass or more, particularly preferably 15% by mass or more, and more particularly preferably 20% by mass or more, with respect to the total mass of the molding material. In addition, the content of the aliphatic polyester is preferably 90% by mass or less, more preferably 70% by mass or less, still more preferably 50% by mass or less, and particularly preferably 40% by mass or less, with respect to the total mass of the molding material. When the content of the aliphatic polyester is within the above range, more favorable mechanical strength tends to be obtained.

### 1.1.2. Polyester-Based Elastomer

The polyester-based elastomer preferably includes, as raw material monomers, an alkyl dicarboxylic acid having 2 to 8 carbon atoms in the alkylene group or a phthalic acid and an alkylene diol having 2 to 8 carbon atoms in the alkylene group. When the polyester-based elastomer includes the above raw material monomers, more favorable mechanical strength tends to be obtained. The polyester-based elastomer is preferably formed by copolymerizing the above-mentioned two raw material monomers. The copolymerization can be performed by a known synthesis method.

Examples of the alkyl dicarboxylic acids include linear saturated aliphatic dicarboxylic acids such as succinic acid, glutaric acid, adipic acid, pimelic acid, suberic acid, azelaic acid, and sebacic acid. These alkyl dicarboxylic acids may have a substituent in the molecular structure. It is preferable to use one or more of these for the synthesis of the polyester-based elastomer.

The phthalic acid may have a substituent in the molecular structure.

Examples of the above-mentioned alkylene diols include divalent alcohols such as 1,2-ethanediol, 1,3-propanediol, 1,4-butanediol, 1,5-pentanediol, 1,6-hexanediol, 1,7-heptanediol, and 1,8-octanediol. It is preferable to use one or more of these for the synthesis of the polyester-based elastomer. The above-mentioned three raw material monomers are relatively easily available and can be applied to industrial or commercial applications.

The polyester-based elastomer may contain other raw material monomers in addition to the raw material monomers described above. Examples of other raw material monomers include styrene, butadiene, acrylic acid, acrylic acid ester, methacrylic acid, methacrylic acid ester, acetonitrile, isobutylene, isoprene, and ethylene, and one or more of these are preferably used. When other raw material monomers are included, more favorable mechanical strength tends to be obtained.

When incorporating other raw material monomers into the polyester-based elastomer, the total mole number of other raw material monomers is 1% or more and less than 50% with respect to the total mole number of the raw material monomers. As a result, more favorable mechanical strength tends to be obtained.

A commercially available product may be used as the polyester-based elastomer. Examples of the commercially available product include ES-A60NX, E-D27N, E-D42N, and ES series (all trade names) from Aron Kasei Co., Ltd. As the polyester-based elastomer, one or more of these can be applied.

The content of the polyester-based elastomer is preferably 1% by mass or more, more preferably 5% by mass or more, still more preferably 10% by mass or more, particularly preferably 15% by mass or more, and more particularly preferably 20% by mass or more, with respect to the total mass of the molding material. In addition, the content of the polyester-based elastomer is preferably 90% by mass or less, more preferably 70% by mass or less, still more preferably 50% by mass or less, and particularly preferably 40% by mass or less, with respect to the total mass of the molding material. When the content of the polyester-based elastomer is within the above range, more favorable mechanical strength tends to be obtained.

### 1.1.3. Identification of Polyester-Based Elastomer

In the form of the molding material or the molded article, the presence or absence of the polyester-based elastomer can be determined by the following physical property analysis and component analysis.

First, in the physical property analysis, the presence or absence of a component having a composite elastic modulus of 100 MPa or less is confirmed. When the above component is included, it is determined that the elastomer component is included. Specifically, for example, the cross section of the molding material or the molded body is measured in a contact mode using a scanning probe microscope NX20 manufactured by Park Systems. As a result, the presence or absence of the component having a composite elastic modulus of 100 MPa can be confirmed. The presence or absence of the elastomer component may be confirmed using a known nanoindenter.

Next, a qualitative analysis using a combination of a thermal decomposition gas chromatography mass spectrometry (GC-MS) method and a Fourier transform infrared spectroscopy (FT-IR) method is performed to determine whether the elastomer component is a polyester-based elastomer. The thermal decomposition GC-MS method is an analysis method for identifying various fragments generated by thermally decomposing a sample. The FT-IR method is an analysis method for identifying the molecular structure of a sample from an infrared absorption spectrum of the sample. As a result, the molecular structure of the sample can be specified.

For the thermal decomposition GC-MS method, for example, a multi-shot pyrolyzer EGA/PY-3030D of Frontier Lab and a GC/MS 5975 of Agilent Technology, which is equipped with the apparatus, are used. For example, in the FT-IR method, Nicolet (registered trademark) 380 Continuum (registered trademark) manufactured by Thermo Fisher Scientific Inc. is used.

### 1.1.4. Other Resins

The resin contained in the molding material according to the present embodiment may include resins other than the aliphatic polyester and the polyester-based elastomer. Examples of the resins include olefin-based resins such as polyethylene and polypropylene, urethane-based resins, acrylic resins, and the like.

### 1. 1. 5. Content and Molecular Weight of Resin

In the molding material according to the present embodiment, the content of the resin is preferably 50% by mass or less, more preferably 40% by mass or less, and still more preferably 35% by mass or less with respect to the total amount of the material.

When the content of the resin within such a range, heat generation during kneading is suppressed by including the first cellulose and the second cellulose and thus the effect that a molded article having excellent color toning properties can be obtained is more remarkably obtained.

In addition, the molecular weight of the aliphatic polyester and the polyester-based elastomer contained in the resin is not particularly limited, and is, for example, 1,000 or more and 1,000,000 or less. The molding material of the present embodiment has excellent appearance and color toning properties without being strongly dependent on the molecular weight of the aliphatic polyester and polyester-based elastomer contained in the resin.

### 1.2. Cellulose

The molding material according to the present embodiment includes cellulose. The cellulose functions as a filler in the molded article, and contributes to an increase in the bulk of the molding material and an improvement in physical properties such as the strength of a molded article.

Cellulose is a natural material derived from plants and is relatively abundant. Therefore, by using cellulose, the reduction of environmental load is promoted as compared with a case of using synthetic fibers. The cellulose fibers are also advantageous in terms of procurement of raw materials and cost. In addition, cellulose has a high theoretical strength among various fibers and also contributes to the improvement of the strength of the molded article. As the cellulose, in addition to using virgin pulp, waste paper, old cloth, and the like may be reused. In addition, a commercially available product may be used as the cellulose.

The cellulose fibers are made mainly of cellulose, and may contain components other than cellulose. Examples of the components other than cellulose include hemicellulose, lignin, and the like. In addition, the cellulose fibers may be subjected to a treatment such as bleaching.

The cellulose used as the molding material of the present embodiment includes a first cellulose having a peak top in a particle diameter region of 3 μm or more and 100 μm or less in a volume-based particle size distribution curve, and a second cellulose having a peak top in a particle diameter region of 50 μm or more and 500 μm or less in a volume-based particle size distribution curve, and the particle diameter of the first cellulose at the peak top is smaller than the particle diameter of the second cellulose at the peak top.

In the present specification, the particle size distribution curve of the cellulose is, for example, a volume-based particle size distribution curve measured by a particle size distribution measuring instrument using a laser diffraction scattering method. The particle size distribution curve can be displayed as a frequency distribution curve in which the horizontal axis represents the particle diameter and the vertical axis represents the frequency (unit: %), or as a cumulative distribution curve in which the horizontal axis represents the particle diameter and the vertical axis represents the cumulative value of the frequency (unit: %). As the laser diffraction scattering type particle diameter distribution measuring apparatus, for example, “LA-500” manufactured by Horiba, Ltd., “SALD-2200” manufactured by Shimadzu Corporation, and the like can be used.

In addition, when the average particle diameter of the cellulose is 50 μm or more and 7, 500 μm or less, for example, using a Fiber Tester Plus manufactured by L&W, the particle size distribution curve of the cellulose may be obtained by setting a 300 mL cellulose dispersion liquid of a sample adjusted to 0.1% by mass in the apparatus and performing measurement. In addition, when the average particle diameter of the cellulose is 3 μm or more and 100 μm or less, for example, using a PITA-04 of a flow type image analysis method, manufactured by Seishin Enterprise Co., Ltd, the particle size distribution curve may be obtained by setting 50 mL of a cellulose dispersion liquid of a sample adjusted to 0.05% by mass to 0.1% by mass in the apparatus and performing measurement. In addition, when the average particle diameter of the cellulose is 3 μm or more and 500 μm or less, for example, the particle size distribution curve may be obtained using a scanning electron microscope Hitachi High-Tech S-4700 by performing scale calibration with a calibration standard sample S2009T manufactured by EM Japan Co., Ltd. in the electron microscope and measuring the length of 100 cellulose fibers selected randomly. Further, when the average particle diameter of the cellulose is 0.02 μm or more and 2000 μm or less, for example, the particle size distribution curve may be obtained using a laser diffraction particle size distribution measuring apparatus MT3300EXII (laser diffraction/Mie scattering method) manufactured by Microtrac Retsch GmbH by setting 20 mL of a cellulose dispersion liquid of a sample adjusted to 0.05% by mass to 0.1% by mass in the apparatus and performing measurement.

The particle size distribution curve of the cellulose may be obtained by any method as long as the method is similar to the above method, and a plurality of the methods may be used in combination.

The detection range of the particle diameter is set to, for example, 1 μm to 500 μm, and the range is set to be divided into, for example, 1,000 parts. The vertical axis is set to represent a volume-based relative particle and the horizontal axis is set to represent a particle diameter. Thus, the particle size distribution curve can be obtained by connecting each plot with a straight line. In addition, the particle diameter when the cumulative frequency of the particle diameter is 10%, 50%, and 90% in the particle size distribution curve is defined as the particle D10, D50, and D90.

When the first cellulose is used alone to obtain the volume-based particle size distribution curve, the first cellulose has a peak top in a particle diameter region of 3 μm or more and 100 μm or less. In addition, the second cellulose has a peak top in a particle diameter region of 50 μm or more and 500 μm or less in the volume-based particle size distribution curve. The particle diameter of the first cellulose at the peak top is smaller than the particle diameter of the second cellulose at the peak top.

The peak top in the particle size distribution curve refers to the particle diameter at the maximum when the particle size distribution curve is displayed as a frequency distribution curve. In addition, the peak top in the particle size distribution curve may be the particle diameter at the inflection point when the particle size distribution curve is displayed as the cumulative distribution curve, and the detection of the peak top in the particle size distribution curve may be performed by displaying the particle size distribution curve as the frequency distribution curve, regarding the particle size distribution curve as a linear function, and detecting a position where the slope becomes 0 when differentiated as the peak top or the peak bottom.

Since the molding material of the present embodiment includes the first cellulose and the second cellulose, when the volume-based particle size distribution curve of the mixture of the first cellulose and the second cellulose is obtained, a double peak distribution is obtained. The peak top on the small particle diameter side in the particle size distribution curve is derived from the first cellulose, and the peak top on the large particle diameter side is derived from the second cellulose.

In addition, the particle diameter of the first cellulose at the peak top is preferably 5% or more and 40% or less, more preferably 7% or more and 35% or less, and still more preferably 10% or more and 30% or less of the particle diameter of the second cellulose at the peak top. By doing so, heat generation during kneading is further suppressed and thus the effect that a molded article having excellent color toning properties can be obtained is more remarkably obtained. In addition, by doing so, a clearer double peak distribution can be shown in the volume-based particle size distribution curve of the mixture of the first cellulose and the second cellulose.

The particle size distribution curve of the first cellulose or the second cellulose alone is obtained by the usual method using a laser diffraction scattering type particle diameter distribution measuring apparatus. In addition, the volume-based particle size distribution curve of the mixture of the first cellulose and the second cellulose can be obtained by the same usual method before the molding material is kneaded. In addition, the measurement can be performed by extracting the resin as necessary after kneading the molding material or after obtaining a molded article. Further, the volume-based particle size distribution curve after kneading the molding material or after obtaining a molded article can be obtained by using a microscope, image analysis, or the like.

The content of the cellulose is preferably 45% by mass or more, more preferably 50% by mass or more, still more preferably 55% by mass or more, even still more preferably 60% by mass or more and particularly preferably 65% by mass or more, with respect to the total mass of the molding material. In addition, the content of the cellulose is preferably 90% by mass or less, more preferably 80% by mass or less, and still more preferably 70% by mass or less with respect to the total mass of the molding material. When the content of the cellulose fibers is within the above range, favorable mechanical strength tends to be obtained. In addition, since the molding material of the present embodiment includes the first cellulose and the second cellulose, even when the content of such celluloses is high, heat generation during kneading and molding is suppressed and thus the effect that a molded article having excellent color toning properties can be obtained is obtained.

The amount of the cellulose in the molding material can be measured by quantifying the total amount of a composite filler by dissolving the molding material in a chloroform solvent and measuring the weight of the residue, and quantifying the amount of the cellulose in the composite filler by fluorescent X-ray analysis (for example, “JSX-1000S” manufactured by JEOL Ltd.).

### 1.3. Other Components

The molding material of the present embodiment may further include a filler. The filler may be an inorganic filler or an organic filler. Examples of the inorganic filler include talc, titanium oxide, calcium carbonate, carbon black, titanium dioxide-coated mica, fish scale foil, bismuth oxychloride, and particles made of an element or an alloy such as aluminum, silver, gold, platinum, nickel, chromium, tin, zinc, indium, titanium, and copper. These inorganic fillers may be classified as pigments.

Examples of the organic filler include azo pigments such as insoluble azo pigments, condensed azo pigments, azo lakes, and chelate azo pigments, polycyclic pigments such as phthalocyanine pigments, perylene and perinone pigments, anthraquinone pigments, quinacridone pigments, dioxane pigments, thioindigo pigments, isoindolinone pigments, and quinophthalone pigments, dye chelates, dye lakes, nitro pigments, nitroso pigments, aniline black, and daylight fluorescent pigments.

When the molding material includes the filler, a molded article having more favorable impact resistance may be obtained. In addition, when the molding material includes the pigment, a molded article having more excellent appearance and color toning properties can be obtained.

The molding material according to the present embodiment may include, for example, components such as a colorant, a flame retardant, an insect repellent, a fungicide, an antioxidant, an ultraviolet absorber, an aggregation inhibitor, and a mold release agent.

### 1.4. Physical Properties and the Like

The molding material according to the present embodiment preferably has a complex viscosity of 600 to 80,000 Pa·sec at 170° C., more preferably 600 to 40,000 Pa·sec, still more preferably 600 to 20,000 Pa·sec, still even more preferably 600 to 10,000 Pa·sec, and particularly preferably 1,000 to 5,000 Pa·sec. When the complex viscosity at 170° C. is within the above range, the color toning properties of the molding material tend to be further improved.

The method for measuring the complex viscosity is not particularly limited, and for example, the complex viscosity can be obtained by measuring the viscoelasticity under the conditions of a measurement temperature of 170° C., a frequency of 1 Hz, and a strain of 8% using “ARES-G2” manufactured by TA Instruments in accordance with JIS K 7244-10 (ISO 6721-10).

### 1.5. Effect, Mechanism, and the Like

According to the molding material, heat generation during kneading is suppressed by including the first cellulose and the second cellulose, and a molded article having excellent color toning properties can be obtained. This is because due to the coexistence of the second cellulose having a large average particle diameter and the first cellulose having a small average particle diameter, the first cellulose can exist in the gaps between the plurality of second celluloses, even when the content of the cellulose is as high as, for example, 40% by mass or more, an increase in viscosity is suppressed, and the material is easily made suitable for injection molding. In addition, since the heat generation during kneading can also be suppressed, burning of the cellulose can be suppressed and the color toning properties can be improved.

### 2. Method for Producing Molding Material

A method for producing a molding material will be described. A known method can be applied to the production of the molding material. Specifically, for example, the following methods can be applied.

First, the above-mentioned raw materials (each component of the molding material) are kneaded with a single screw kneader or a twin screw kneader and the kneaded product is formed into a strand shape. Next, the material is pelletized to form a pellet-shaped molding material.

In addition, the following method may also be applied as a method for producing the molding material. First, waste paper or pulp material is coarsely crushed by a shredder to obtain cellulose. Then, the cellulose and a resin containing an aliphatic polyester and a polyester-based elastomer are weighed and kneaded. Next, the kneaded raw material is accumulated in the air to obtain a sheet-like sediment. Since the sediment contains a large amount of air and has a low density, the sediment is compressed with a calendar device to remove the air and increase the density. Next, the heating is performed in a non-contact manner by using a heating furnace, and then heat pressing is performed by using a heat press device.

In the heating furnace and the heat press device, it is preferable to perform heating at a temperature substantially 20° C. higher than the melting temperature of the resin. As a result, a sheet in which each raw material is dispersed with suppressed bias tends to be formed.

Next, the sheet is cut into a desired shape by a shredder to form a pellet-shaped molding material. The desired shape of the molding material is not particularly limited, and is a substantially cubic shape of 2 mm³ to 5 mm³. The molding material is produced by the above method. The method for producing the molding material is not limited to the above.

### 3. Examples and Comparative Examples

Hereinafter, the present disclosure will be described in more detail with reference to examples, but the present disclosure is not limited to these examples. Hereinafter, “%” is based on mass unless otherwise specified.

### 3.1. Production of Molding Material and Evaluation Sample

The molding materials according to each Example and each Comparative Example were produced in accordance with the compositions shown in Tables 1 and 2.

Specifically, each component was charged into a twin screw kneader “KZW15TW-45 MG” manufactured by Technobell Co., Ltd. and kneaded to have the compositions shown in Tables 1 and 2. For the kneading conditions, the maximum heating temperature was set to 180° C. and the extrusion discharge rate was set to 1 kg/hr. Next, the material was stranded and then formed into a pellet-shaped molding material with a pelletizer.

The molding materials according to each Example and each Comparative Example were used to carry out molding by injection molding or pressing. Specifically, in both the injection molding and the pressing, the heating temperature of the molding material was set to 200° C. As an injection molding apparatus, “THX40-5V” manufactured by Nissei Plastic Industrial Co., Ltd., was used and as a pressing apparatus, “PHKS-40ABS” manufactured by Towa Seiki Co., Ltd. was used.

Explanations regarding Tables 1 and 2 will be supplemented.
Polyester-based elastomer (trade name “ES-A60NX”, Aronkasei Co., Ltd.)
Polybutylene succinate FZ71 (trade name “BioPBS FZ71”, manufactured by Mitsubishi Chemical Corporation, weight average molecular weight MW: 70,000)
Polybutylene succinate FZ91 (trade name “BioPBS FZ91”, manufactured by Mitsubishi Chemical Corporation, weight average molecular weight MW: 92,000)
Polylactic acid: TERRAMAC TE-2000, Unitika Ltd.
Polyhydroxyalkanoate (P3HBH, poly [(R)-3-hydroxybutyrate-co-(R)-3-hydroxyhexanoate])
EPDM (ethylene propylene diene rubber, trade name “NORDEL (registered trademark) 3720P”, Dow Toray Co., Ltd.)
200 μm spherical shape (Viscopearl “D-2010” manufactured by Rengo Co., Ltd., aspect ratio: 1.0, distribution width: 1.2, crystallization rate: 65% to 70%, type II crystal structure)
30 μm spherical shape (Viscopearl “D-30” manufactured by Rengo Co., Ltd., aspect ratio: 1.0, distribution width: 1.8, crystallization rate: 70% to 75%, type II crystal structure)
5 μm spherical shape (Viscopearl “D-5” manufactured by Rengo Co., Ltd., aspect ratio: 1.0, distribution width: 1.1, crystallization rate: 70% to 75%, type II crystal structure)
40 μm scale-like shape (obtained by processing “Guaiba BEKP” manufactured by CMPC with “KGW-G015” manufactured by West, aspect ratio: 1.5, distribution width: 3.8, crystallization rate: 0% to 10%, amorphous)
350 μm fibrous shape (obtained by defibrating “Guaiba BEKP” manufactured by CMPC in a twin screw kneader, aspect ratio: 17.5, distribution width: 1.0, crystallization rate: 58% to 65%, type I crystal structure)
200 μm fibrous shape (“KC Flock W-80”, manufactured by Nippon Paper Industries Co., Ltd., aspect ratio: 5.0, distribution width: 3.5, crystallization rate: 63% to 67%, type I crystal structure)
140 μm fibrous shape (“KC Flock W-100”, manufactured by Nippon Paper Industries Co., Ltd., aspect ratio: 7.0, distribution width: 3.2, crystallization rate: 63% to 67%, type I crystal structure)
40 μm fibrous shape (“KC Flock W-300G”, manufactured by Nippon Paper Industries Co., Ltd., aspect ratio: 6.7, distribution width: 2.5, crystallization rate: 63% to 67%, type I crystal structure)
10 μm fibrous shape (“NP Fiber W-6”, manufactured by Nippon Paper Industries Co., Ltd., aspect ratio: 4.7, distribution width: 1.5, crystallization rate: 65% to 69%, type I crystal structure)
Talc (NANOACE, manufactured by Nippon Talc Co., Ltd., volume average particle diameter: 1.5 μm)
Calcium carbonate (manufactured by Takehara Chemical Industrial Co., Ltd., volume average particle diameter: 4.5 μm)

In Table 2, “X” in the evaluation of the complex viscosity indicates that kneading was not possible.

### 3.2. Evaluation Test

### 3.2.1. Evaluation of Complex Viscosity and Injection Moldability

In the molding materials according to each Example and each Comparative Example obtained above, the viscoelasticity was measured under the conditions of a measurement temperature of 170° C., a frequency of 1 Hz, and a strain of 8% using “ARES-G2” manufactured by TA Instruments, in accordance with JIS K 7244-10 (ISO 6721-10), and the complex viscosity was obtained. The injection moldability was evaluated based on the obtained complex viscosity by the following determination criteria.

### Determination Criteria

A: Complex viscosity is less than 100 kPa·sec.
B: Complex viscosity is 100 kPa·sec or more and 1,000 kPa·sec or less.
C: Complex viscosity is more than 1,000 kPa·sec.

### 3.2.2. Evaluation of Appearance and Color Toning Properties

In the evaluation samples according to each Example and each Comparative Example obtained above, the L* value was measured using a fluorescence spectrophotometer (FD-7, Konica Minolta Inc.) and determined according to the following criteria.

### Determination Criteria

A: L* of 70 or more
B: L* of less than 70

### 3.2.3. Evaluation of Charpy Impact Strength

In the evaluation samples according to each Example and each Comparative Example obtained above, the shape of the test piece was a rectangular plate shape having a long side of 80 mm±2 mm, a short side of 4.0 mm±0.2 mm, and a thickness of 10.0 mm±0.2 mm, and the Charpy impact strength was measured in accordance with ISO 179 (JIS K 7111) using an “impact tester IT” manufactured by Toyo Seiki Seisaku-sho, Ltd. as a testing apparatus, with a hammer weight of 4 J (WR 2.14 N/m), a lifting angle of 150°, a notch remaining width of 8.0 mm±0.2 mm, and a notch angle of 45°.

### 3.2.4. Determination

The above evaluation was determined based on the following criteria, and the molding material of each example was evaluated.
A: Both injection moldability and appearance and color toning properties are A, and Charpy impact strength is 6 kJ/m² or more.
B: Both injection moldability and appearance and color toning properties are A, and Charpy impact strength is less than 6 kJ/m².
C: Appearance and color toning properties are B.
D: Not kneadable.

### 3.3. Evaluation of Result

It was found that the molding materials of each Example, each of which is a molding material including cellulose, an aliphatic polyester, and a polyester-based elastomer, in which the cellulose includes a first cellulose having a peak top in a particle diameter region of 3 μm or more and 100 μm or less in a volume-based particle size distribution curve, and a second cellulose having a peak top in a particle diameter region of 50 μm or more and 500 μm or less in a volume-based particle size distribution curve, and a particle diameter of the first cellulose at the peak top is smaller than a particle diameter of the second cellulose at the peak top, had favorable color toning properties, and the comprehensive evaluation was also favorable.

The above-described embodiments are examples, and the present disclosure is not limited to thereto. For example, each embodiment and each modification example can be combined as appropriate.

The present disclosure includes a configuration substantially the same as the configuration described in the embodiment, for example, a configuration having the same function, method, and result, or a configuration having the same purpose and effect. Further, the present disclosure includes configurations in which non-essential parts of the configuration described in the embodiments are replaced. In addition, the present disclosure includes configurations that achieve the same effects or configurations that can achieve the same objects as those of the configurations described in the embodiment. Further, the present disclosure includes configurations in which a known technology is added to the configurations described in the embodiments.

The following contents are derived from the above-described embodiments and modification examples.

A molding material including:
a resin; and
cellulose, in which
the resin includes an aliphatic polyester and a polyester-based elastomer,
the cellulose includes a first cellulose having a peak top in a particle diameter region of 3 μm or more and 100 μm or less in a volume-based particle size distribution curve, and a second cellulose having a peak top in a particle diameter region of 50 μm or more and 500 μm or less in a volume-based particle size distribution curve, and
a particle diameter of the first cellulose at the peak top is smaller than a particle diameter of the second cellulose at the peak top.

According to the molding material, heat generation during kneading is suppressed by including the first cellulose and the second cellulose, and a molded article having excellent color toning properties can be obtained.

In the above molding material,
the complex viscosity may be 600 Pa·s or more and 80,000 Pa·s or less.

According to the molding material, heat generation during kneading is further suppressed, and a molded article can be obtained with favorable moldability.

The molding material may further include a filler.

According to the molding material, a molded article having more favorable impact resistance can be obtained.

In the molding material,
a content of the resin may be 50% by mass or less with respect to a total amount of the material.

According to the molding material, heat generation during kneading is suppressed by including the first cellulose and the second cellulose and thus the effect that a molded article having excellent color toning properties can be obtained is more remarkably obtained.

In the above molding material,
the particle diameter of the first cellulose at the peak top may be 5% or more and 40% or less of the particle diameter of the second cellulose at the peak top.

According to the molding material, heat generation during kneading is suppressed and thus the effect that a molded article having excellent color toning properties can be obtained is more remarkably obtained.

In the molding material,
a content of the cellulose may be 60% by mass or more.

According to the molding material, heat generation during kneading is suppressed and thus the effect that a molded article having excellent color toning properties can be obtained is more remarkably obtained.

A second embodiment of the present disclosure will be described below. The embodiments described below describe examples of the present disclosure. The present disclosure is not limited to the following embodiments, and includes various modifications implemented within a range not changing a gist of the present disclosure. It should be noted that not all of the configurations described below are essential configurations of the present disclosure.

### 1. Molding Material

A molding material according to the present embodiment includes a resin, and cellulose. The resin includes polylactic acid and a biodegradable polyester other than the polylactic acid, the cellulose includes a first cellulose having a peak top in a particle diameter region of 3 μm or more and 100 μm or less in a volume-based particle size distribution curve, and a second cellulose having a peak top in a particle diameter region of 50 μm or more and 500 μm or less in a volume-based particle size distribution curve, and a particle diameter of the first cellulose at the peak top is smaller than a particle diameter of the second cellulose at the peak top.

### 1.1. Biodegradable Resin

The molding material of the present embodiment includes a biodegradable resin. The biodegradable resin can form a matrix in the molding material. The molding material is a composite material having a structure in which cellulose described later is dispersed in the biodegradable resin.

The biodegradable resin includes polylactic acid and a biodegradable polyester other than the polylactic acid. The polylactic acid and the biodegradable polyester other than the polylactic acid have thermoplasticity, and when a molded article is produced from the molding material, the polylactic acid and the biodegradable polyester are melted to bind the cellulose fibers to each other. In addition, the polylactic acid and the biodegradable polyester other than the polylactic acid contribute to physical properties of the molded article together with the cellulose fibers. Further, the polylactic acid and the biodegradable polyester other than the polylactic acid have a possibility of being produced and used as bioplastics in the future, and are materials that are expected to promote the reduction of environmental load.

### 1.1.1. Polylactic Acid

The biodegradable resin includes polylactic acid. Polylactic acid is a thermoplastic resin obtained by polymerization by a lactide method, direct polymerization, or the like. Examples of the polylactic acid include poly-L-lactic acid obtained by polymerization of L-lactic acid only, poly-D-lactic acid obtained by polymerization of D-lactic acid only, poly-DL-lactic acid obtained by polymerization of L-lactic acid and D-lactic acid, and the like.

The content of the polylactic acid is preferably 5% by mass or more, more preferably 10% by mass or more, and still more preferably 15% by mass or more with respect to the total amount of the molding material. In addition, the content of the polylactic acid is preferably 35% by mass or less, more preferably 30% by mass or less, and still more preferably 25% by mass or less with respect to the total amount of the molding material. When the content of the polylactic acid is within the above range, the color toning properties can be improved, and more favorable mechanical strength tends to be obtained.

1.1.2. Polylactic Acid and Biodegradable Polyester Other than Polylactic Acid

The biodegradable polyester other than the polylactic acid is not particularly limited as long as the resin is biodegradable, and may be, for example, a saturated aliphatic polyester or an unsaturated aliphatic polyester. In addition, the aliphatic polyester may be linear or cyclic. Among these, it is preferable that the aliphatic polyester having biodegradability is preferably a saturated aliphatic polyester. In addition, the aliphatic polyester is preferably a highly polar polyester.

The aliphatic polyester is a polyester having no aromatic ring, and examples thereof include a polycondensate of an aliphatic hydroxycarboxylic acid, a polycondensate of an aliphatic dicarboxylic acid and an aliphatic diol, a ring-opening polymer of an aliphatic lactone, a plurality of copolymers of these monomers, and transesterification products of these polymers. In addition, the aliphatic polyester may include a structure derived from a monomer that can form three or more ester bonds such as an aliphatic triol or an aliphatic tricarboxylic acid, or a monomer having an alicyclic skeleton.

Examples of the aliphatic polyester having biodegradability include poly-L-lactic acid (PLLA), poly-D-lactic acid (PDLA), a random copolymer of L-lactic acid and D-lactic acid, polylactic acid such as a stereo complex of L-lactic acid and D-lactic acid, polycaprolactone, polypivalolactone, polyhydroxybutyric acid (P3HB), polyhydroxyvaleric acid, poly(3-hydroxybutyrate-co-3-hydroxyhexanoate), poly [(R)-3-hydroxybutyrate-co-(R)-3-hydroxyhexanoate] (P3HBH), poly(3-hydroxybutyrate-co-3-hydroxyvalerate), polylactic acid-co-polyglycolic acid, polylactic acid-co-polycaprolactone, polyethylene succinate, polypropylene succinate, polybutylene succinate (PBS), polyethylene adipate, polypropylene adipate, polybutylene adipate (PBA), polyneopentylglycol adipate, polyethylene sebacate, polypropylene sebacate, polybutylene sebacate, polyethylene succinate/adipate, polypropylene succinate/adipate, and polybutylene succinate/adipate.

As the biodegradable polyester other than the polylactic acid, a polyester-based elastomer may be used as long as the material has biodegradability. The polyester-based elastomer preferably includes, as raw material monomers, an alkyl dicarboxylic acid having 2 to 8 carbon atoms in the alkylene group and an alkylene diol having 2 to 8 carbon atoms in the alkylene group. When the polyester-based elastomer includes the above raw material monomers, more favorable mechanical strength tends to be obtained. The polyester-based elastomer is preferably formed by copolymerizing the above-mentioned two raw material monomers. The copolymerization can be performed by a known synthesis method.

Examples of the alkyl dicarboxylic acids include linear saturated aliphatic dicarboxylic acids such as succinic acid, glutaric acid, adipic acid, pimelic acid, suberic acid, azelaic acid, and sebacic acid. These alkyl dicarboxylic acids may have a substituent in the molecular structure. It is preferable to use one or more of these for the synthesis of the polyester-based elastomer.

Examples of the above-mentioned alkylene diols include divalent alcohols such as 1,2-ethanediol, 1,3-propanediol, 1,4-butanediol, 1,5-pentanediol, 1,6-hexanediol, 1,7-heptanediol, and 1,8-octanediol. It is preferable to use one or more of these for the synthesis of the polyester-based elastomer. The above-mentioned three raw material monomers are relatively easily available and can be applied to industrial or commercial applications.

A commercially available product may be used as the polyester-based elastomer having biodegradability. Examples of the commercially available product include ES-A60NX, E-D27N, E-D42N, and ES series (all trade names) from Aron Kasei Co., Ltd. As the polyester-based elastomer, one or more of these can be applied.

In the form of the molding material or the molded article, the presence or absence of the polyester-based elastomer can be determined by the following physical property analysis and component analysis.

First, in the physical property analysis, the presence or absence of a component having a composite elastic modulus of 100 MPa or less is confirmed. When the above component is included, it is determined that the elastomer component is included. Specifically, for example, the cross section of the molding material or the molded body is measured in a contact mode using a scanning probe microscope NX20 manufactured by Park Systems. As a result, the presence or absence of the component having a composite elastic modulus of 100 MPa can be confirmed. The presence or absence of the elastomer component may be confirmed using a known nanoindenter.

Next, a qualitative analysis using a combination of a thermal decomposition gas chromatography mass spectrometry (GC-MS) method and a Fourier transform infrared spectroscopy (FT-IR) method is performed to determine whether the elastomer component is a polyester-based elastomer. The thermal decomposition GC-MS method is an analysis method for identifying various fragments generated by thermally decomposing a sample. The FT-IR method is an analysis method for identifying the molecular structure of a sample from an infrared absorption spectrum of the sample. As a result, the molecular structure of the sample can be specified.

For the thermal decomposition GC-MS method, for example, a multi-shot pyrolyzer EGA/PY-3030D of Frontier Lab and a GC/MS 5975 of Agilent Technology, which is equipped with the apparatus, are used. For example, in the FT-IR method, Nicolet (registered trademark) 380 Continuum (registered trademark) manufactured by Thermo Fisher Scientific Inc. is used.

The content of the biodegradable polyester other than the polylactic acid is preferably 1% by mass or more, more preferably 5% by mass or more, still more preferably 10% by mass or more, particularly preferably 15% by mass or more, and more particularly preferably 20% by mass or more, with respect to the total mass of the molding material. In addition, the content of the aliphatic polyester is preferably 90% by mass or less, more preferably 70% by mass or less, still more preferably 50% by mass or less, and particularly preferably 40% by mass or less, with respect to the total mass of the molding material. When the content of the aliphatic polyester is within the above range, more favorable mechanical strength tends to be obtained.

### 1.1.2. Content and Molecular Weight of Biodegradable Resin

In the molding material according to the present embodiment, the content of the biodegradable resin is preferably 50% by mass or less, more preferably 40% by mass or less, and still more preferably 35% by mass or less with respect to the total amount of the material.

When the content of the biodegradable resin within such a range, heat generation during kneading is suppressed by including the first cellulose and the second cellulose and thus the effect that a molded article having excellent color toning properties can be obtained is more remarkably obtained.

In addition, the molecular weight of the polylactic acid and the biodegradable polyester other than the polylactic acid contained in the biodegradable resin is not particularly limited, and is, for example, 1,000 or more and 1,000,000 or less. The molding material of the present embodiment exhibits excellent appearance and color toning properties without being strongly dependent on the molecular weight of the polylactic acid and biodegradable polyester other than the polylactic acid in the resin.

### 1.2. Cellulose

The molding material according to the present embodiment includes cellulose. The cellulose functions as a filler in the molded article, and contributes to an increase in the bulk of the molding material and an improvement in physical properties such as the strength of a molded article.

Cellulose is a natural material derived from plants and is relatively abundant. Therefore, by using cellulose, the reduction of environmental load is promoted as compared with a case of using synthetic fibers. The cellulose fibers are also advantageous in terms of procurement of raw materials and cost. In addition, cellulose has a high theoretical strength among various fibers and also contributes to the improvement of the strength of the molded article. As the cellulose, in addition to using virgin pulp, waste paper, old cloth, and the like may be reused. In addition, a commercially available product may be used as the cellulose.

The cellulose fibers are made mainly of cellulose, and may contain components other than cellulose. Examples of the components other than cellulose include hemicellulose, lignin, and the like. In addition, the cellulose fibers may be subjected to a treatment such as bleaching.

The cellulose used as the molding material of the present embodiment includes a first cellulose having a peak top in a particle diameter region of 3 μm or more and 100 μm or less in a volume-based particle size distribution curve, and a second cellulose having a peak top in a particle diameter region of 50 μm or more and 500 μm or less in a volume-based particle size distribution curve, and the particle diameter of the first cellulose at the peak top is smaller than the particle diameter of the second cellulose at the peak top.

In the present specification, the particle size distribution curve of the cellulose is, for example, a volume-based particle size distribution curve measured by a particle size distribution measuring instrument using a laser diffraction scattering method. The particle size distribution curve can be displayed as a frequency distribution curve in which the horizontal axis represents the particle diameter and the vertical axis represents the frequency (unit: %), or as a cumulative distribution curve in which the horizontal axis represents the particle diameter and the vertical axis represents the cumulative value of the frequency (unit: %). As the laser diffraction scattering type particle diameter distribution measuring apparatus, for example, “LA-500” manufactured by Horiba, Ltd., “SALD-2200” manufactured by Shimadzu Corporation, and the like can be used.

In addition, when the average particle diameter of the cellulose is 50 μm or more and 7, 500 μm or less, for example, using a Fiber Tester Plus manufactured by L&W, the particle size distribution curve of the cellulose may be obtained by setting a 300 mL cellulose dispersion liquid of a sample adjusted to 0.1% by mass in the apparatus and performing measurement. In addition, when the average particle diameter of the cellulose is 3 μm or more and 100 μm or less, for example, using a PITA-04 of a flow type image analysis method, manufactured by Seishin Enterprise Co., Ltd, the particle size distribution curve may be obtained by setting 50 mL of a cellulose dispersion liquid of a sample adjusted to 0.05% by mass to 0.1% by mass in the apparatus and performing measurement. In addition, when the average particle diameter of the cellulose is 3 μm or more and 500 μm or less, for example, the particle size distribution curve may be obtained using a scanning electron microscope Hitachi High-Tech S-4700 by performing scale calibration with a calibration standard sample S2009T manufactured by EM Japan Co., Ltd. in the electron microscope and measuring the length of 100 cellulose fibers selected randomly. Further, when the average particle diameter of the cellulose is 0.02 μm or more and 2,000 μm or less, for example, the particle size distribution curve may be obtained using a laser diffraction particle size distribution measuring apparatus MT3300EXII (laser diffraction/Mie scattering method) manufactured by Microtrac Retsch GmbH by setting 20 mL of a cellulose dispersion liquid of a sample adjusted to 0.05% by mass to 0.1% by mass in the apparatus and performing measurement.

The particle size distribution curve of the cellulose may be obtained by any method as long as the method is similar to the above method, and a plurality of the methods may be used in combination.

The detection range of the particle diameter is set to, for example, 1 μm to 500 μm, and the range is set to be divided into, for example, 1,000 parts. The vertical axis is set to represent a volume-based relative particle and the horizontal axis is set to represent a particle diameter. Thus, the particle size distribution curve can be obtained by connecting each plot with a straight line. In addition, the particle diameter when the cumulative frequency of the particle diameter is 10%, 50%, and 90% in the particle size distribution curve is defined as the particle D10, D50, and D90.

When the first cellulose is used alone to obtain the volume-based particle size distribution curve, the first cellulose has a peak top in a particle diameter region of 3 μm or more and 100 μm or less. In addition, the second cellulose has a peak top in a particle diameter region of 50 μm or more and 500 μm or less in the volume-based particle size distribution curve. The particle diameter of the first cellulose at the peak top is smaller than the particle diameter of the second cellulose at the peak top.

The peak top in the particle size distribution curve refers to the particle diameter at the maximum when the particle size distribution curve is displayed as a frequency distribution curve. In addition, the peak top in the particle size distribution curve may refer to the particle diameter at the inflection point when the particle size distribution curve is displayed as a cumulative distribution curve. Further, the detection of the peak top in the particle size distribution curve may be performed by displaying the particle size distribution curve as a frequency distribution curve, regarding the particle size distribution curve as a linear function, and detecting a position where the slope becomes 0 when differentiated as the peak top or the peak bottom.

Since the molding material of the present embodiment includes the first cellulose and the second cellulose, when the volume-based particle size distribution curve of the mixture of the first cellulose and the second cellulose is obtained, a double peak distribution is obtained. The peak top on the small particle diameter side in the particle size distribution curve is derived from the first cellulose, and the peak top on the large particle diameter side is derived from the second cellulose.

In addition, the particle diameter of the first cellulose at the peak top is preferably 5% or more and 40% or less, more preferably 7% or more and 35% or less, and still more preferably 10% or more and 30% or less of the particle diameter of the second cellulose at the peak top. By doing so, heat generation during kneading is further suppressed and thus the effect that a molded article having excellent color toning properties can be obtained is more remarkably obtained. In addition, by doing so, a clearer double peak distribution can be shown in the volume-based particle size distribution curve of the mixture of the first cellulose and the second cellulose.

The particle size distribution curve of the first cellulose or the second cellulose alone is obtained by the usual method using a laser diffraction scattering type particle diameter distribution measuring apparatus. In addition, the volume-based particle size distribution curve of the mixture of the first cellulose and the second cellulose can be obtained by the same usual method before the molding material is kneaded. In addition, the measurement can be performed by extracting the resin as necessary after kneading the molding material or after obtaining a molded article. Further, the volume-based particle size distribution curve after kneading the molding material or after obtaining a molded article can be obtained by using a microscope, image analysis, or the like.

The content of the cellulose is preferably 45% by mass or more, more preferably 50% by mass or more, still more preferably 55% by mass or more, even still more preferably 60% by mass or more and particularly preferably 65% by mass or more, with respect to the total mass of the molding material. In addition, the content of the cellulose is preferably 90% by mass or less, more preferably 80% by mass or less, and still more preferably 70% by mass or less with respect to the total mass of the molding material. When the content of the cellulose fibers is within the above range, favorable mechanical strength tends to be obtained. In addition, since the molding material of the present embodiment includes the first cellulose and the second cellulose, even when the content of such celluloses is high, heat generation during kneading and molding is suppressed and thus the effect that a molded article having excellent color toning properties can be obtained is obtained.

The amount of the cellulose in the molding material can be measured by quantifying the total amount of a composite filler by dissolving the molding material in a chloroform solvent and measuring the weight of the residue, and quantifying the amount of the cellulose in the composite filler by fluorescent X-ray analysis (for example, “JSX-1000S” manufactured by JEOL Ltd.).

### 1.3. Other Components

The molding material of the present embodiment may further include a filler. The filler may be an inorganic filler or an organic filler. Examples of the inorganic filler include talc, titanium oxide, calcium carbonate, carbon black, titanium dioxide-coated mica, fish scale foil, bismuth oxychloride, and particles made of an element or an alloy such as aluminum, silver, gold, platinum, nickel, chromium, tin, zinc, indium, titanium, and copper. These inorganic fillers may be classified as pigments.

Examples of the organic filler include azo pigments such as insoluble azo pigments, condensed azo pigments, azo lakes, and chelate azo pigments, polycyclic pigments such as phthalocyanine pigments, perylene and perinone pigments, anthraquinone pigments, quinacridone pigments, dioxane pigments, thioindigo pigments, isoindolinone pigments, and quinophthalone pigments, dye chelates, dye lakes, nitro pigments, nitroso pigments, aniline black, and daylight fluorescent pigments.

When the molding material includes the filler, a molded article having more favorable impact resistance may be obtained. In addition, when the molding material includes the pigment, a molded article having more excellent appearance and color toning properties can be obtained.

The molding material according to the present embodiment may include, for example, components such as a colorant, a flame retardant, an insect repellent, a fungicide, an antioxidant, an ultraviolet absorber, an aggregation inhibitor, and a mold release agent.

### 1.4. Physical Properties and the Like

The molding material according to the present embodiment preferably has a complex viscosity of 600 to 80,000 Pa·sec at 170° C., more preferably 600 to 40,000 Pa·sec, still more preferably 600 to 20,000 Pa·sec, even still more preferably 600 to 10,000 Pa·sec, and particularly preferably 1,000 to 5,000 Pa·sec. When the complex viscosity at 170° C. is within the above range, the color toning properties of the molding material tend to be further improved.

The method for measuring the complex viscosity is not particularly limited, and for example, the complex viscosity can be obtained by measuring the viscoelasticity under the conditions of a measurement temperature of 170° C., a frequency of 1 Hz, and a strain of 8% using “ARES-G2” manufactured by TA Instruments in accordance with JIS K 7244-10 (ISO 6721-10).

### 1.5. Effect, Mechanism, and the Like

According to the molding material, heat generation during kneading is suppressed by including the first cellulose and the second cellulose, and a molded article having excellent color toning properties can be obtained. This is because due to the coexistence of the second cellulose having a large average particle diameter and the first cellulose having a small average particle diameter, the first cellulose can exist in the gaps between the plurality of second celluloses, even when the content of the cellulose is as high as, for example, 40% by mass or more, an increase in viscosity is suppressed, and the material is easily made suitable for injection molding. In addition, since the heat generation during kneading can also be suppressed, burning of the cellulose can be suppressed and the color toning properties can be improved.

In addition, since the biodegradable resin is used, a biodegradable molded article can be produced. Further, a molded article having excellent mechanical properties is obtained by using the polylactic acid and the polyester other than the polylactic acid in combination.

### 2. Method for Producing Molding Material

A method for producing a molding material will be described. A known method can be applied to the production of the molding material. Specifically, for example, the following methods can be applied.

First, the above-mentioned raw materials (each component of the molding material) are kneaded with a single screw kneader or a twin screw kneader and the kneaded product is formed into a strand shape. Next, the material is pelletized to form a pellet-shaped molding material.

In addition, the following method may also be applied as a method for producing the molding material. First, waste paper or pulp material is coarsely crushed by a shredder to obtain cellulose. Then, the cellulose and a resin containing polylactic acid and a biodegradable polyester other than the polylactic acid are weighed and kneaded. Next, the kneaded raw material is accumulated in the air to obtain a sheet-like sediment. Since the sediment contains a large amount of air and has a low density, the sediment is compressed with a calendar device to remove the air and increase the density. Next, the heating is performed in a non-contact manner by using a heating furnace, and then heat pressing is performed by using a heat press device.

In the heating furnace and the heat press device, it is preferable to perform heating at a temperature substantially 20° C. higher than the melting temperature of the resin. As a result, a sheet in which each raw material is dispersed with suppressed bias tends to be formed.

Next, the sheet is cut into a desired shape by a shredder to form a pellet-shaped molding material. The desired shape of the molding material is not particularly limited, and is a substantially cubic shape of 2 mm³ to 5 mm³. The molding material is produced by the above method. The method for producing the molding material is not limited to the above.

### 3. Molded Article

A molded article according to an embodiment of the present disclosure is molded by using the molding material described above.

The molded article according to the present embodiment can be obtained by using the above-mentioned molding material, and has biodegradability, excellent mechanical strength, and excellent color toning properties.

The molded article according to the present embodiment is preferably a container or a tableware. Although there is a higher possibility that a consumer inappropriately discards such a molded article in the natural world, the molded article according to the present embodiment has excellent biodegradability and color toning properties, and thus the possibility of the molded article being inappropriately discarded can be reduced.

The container is not particularly limited, and examples thereof include a food container, an agricultural and gardening container, a blister pack container, a press-through pack container, a fluid container, and the like.

Specific examples of the food container include a tray for fresh food, an instant food container, a fast food container, a lunch box, a beverage container, and the like. Specific examples of the agricultural and gardening container include a seedling pot. Specific examples of the blister pack container include packaging and packaging containers for a wide variety of products for mechanical and industrial applications such as office supplies, toys, and dry batteries, in addition to food. Specific examples of the fluid container include an ink cartridge exterior, a cosmetic container, and the like.

The tableware is not particularly limited, and examples thereof include a plate, a bowl, a pot, chopsticks, a spoon, a fork, a knife, and the like.

### 4. Examples and Comparative Examples

Hereinafter, the present disclosure will be described in more detail with reference to examples, but the present disclosure is not limited to these examples. Hereinafter, “%” is based on mass unless otherwise specified.

### 4.1. Production of Molding Material and Evaluation Sample

The molding materials according to each Example and each Comparative Example were produced in accordance with the compositions shown in Tables 3 and 4.

Specifically, each component was charged into a twin screw kneader “KZW15TW-45 MG” manufactured by Technobell Co., Ltd. and kneaded to have the compositions shown in Tables 3 and 4. For the kneading conditions, the maximum heating temperature was set to 180° C. and the extrusion discharge rate was set to 1 kg/hr. Next, the material was stranded and then formed into a pellet-shaped molding material with a pelletizer.

The molding materials according to each Example and each Comparative Example were used to carry out molding by injection molding or pressing. Specifically, in both the injection molding and the pressing, the heating temperature of the molding material was set to 200° C. As an injection molding apparatus, “THX40-5V” manufactured by Nissei Plastic Industrial Co., Ltd., was used and as a pressing apparatus, “PHKS-40ABS” manufactured by Towa Seiki Co., Ltd. was used.

Explanations regarding Tables 3 and 4 will be supplemented.
Polyester-based elastomer (trade name “ES-A60NX”, Aronkasei Co., Ltd.)
Polybutylene succinate FZ71 (trade name “BioPBS FZ71”, manufactured by Mitsubishi Chemical Corporation, weight average molecular weight MW: 70,000)
Polybutylene succinate FZ91 (trade name “BioPBS FZ91”, manufactured by Mitsubishi Chemical Corporation, weight average molecular weight MW: 92,000)
Polylactic acid: TERRAMAC TE-2000, Unitika Ltd.
Polyhydroxyalkanoate (P3HBH, poly [(R)-3-hydroxybutyrate-co-(R)-3-hydroxyhexanoate])
EPDM (ethylene propylene diene rubber, trade name “NORDEL (registered trademark) 3720P”, Dow Toray Co., Ltd.)
200 μm spherical shape (Viscopearl “D-2010” manufactured by Rengo Co., Ltd., aspect ratio: 1.0, distribution width: 1.2, crystallization rate: 65% to 70%, type II crystal structure)
30 μm spherical shape (Viscopearl “D-30” manufactured by Rengo Co., Ltd., aspect ratio: 1.0, distribution width: 1.8, crystallization rate: 70% to 75%, type II crystal structure)
5 μm spherical shape (Viscopearl “D-5” manufactured by Rengo Co., Ltd., aspect ratio: 1.0, distribution width: 1.1, crystallization rate: 70% to 75%, type II crystal structure)
40 μm scale-like shape (obtained by processing “Guaiba BEKP” manufactured by CMPC with “KGW-G015” manufactured by West, aspect ratio: 1.5, distribution width: 3.8, crystallization rate: 0% to 10%, amorphous)
350 μm fibrous shape (obtained by defibrating “Guaiba BEKP” manufactured by CMPC in a twin screw kneader, aspect ratio: 17.5, distribution width: 1.0, crystallization rate: 58% to 65%, type I crystal structure)
200 μm fibrous shape (“KC Flock W-80”, manufactured by Nippon Paper Industries Co., Ltd., aspect ratio: 5.0, distribution width: 3.5, crystallization rate: 63% to 67%, type I crystal structure)
140 μm fibrous shape (“KC Flock W-100”, manufactured by Nippon Paper Industries Co., Ltd., aspect ratio: 7.0, distribution width: 3.2, crystallization rate: 63% to 67%, type I crystal structure)
40 μm fibrous shape (“KC Flock W-300G”, manufactured by Nippon Paper Industries Co., Ltd., aspect ratio: 6.7, distribution width: 2.5, crystallization rate: 63% to 67%, type I crystal structure)
10 μm fibrous shape (“NP Fiber W-6”, manufactured by Nippon Paper Industries Co., Ltd., aspect ratio: 4.7, distribution width: 1.5, crystallization rate: 65% to 69%, type I crystal structure)
Talc (NANOACE, manufactured by Nippon Talc Co., Ltd., volume average particle diameter: 1.5 μm)
Calcium carbonate (manufactured by Takehara Chemical Industrial Co., Ltd., volume average particle diameter: 4.5 μm)

In Table 4, “X” in the evaluation of the complex viscosity indicates that kneading was not possible.

### 4.2. Evaluation Test

### 4.2.1. Evaluation of Complex Viscosity and Injection Moldability

In the molding materials according to each Example and each Comparative Example obtained above, the viscoelasticity was measured under the conditions of a measurement temperature of 170° C., a frequency of 1 Hz, and a strain of 8% using “ARES-G2” manufactured by TA Instruments, in accordance with JIS K 7244-10 (ISO 6721-10), and the complex viscosity was obtained. The injection moldability was evaluated based on the obtained complex viscosity by the following determination criteria.

### Determination Criteria

A: Complex viscosity is less than 100 kPa·sec.
B: Complex viscosity is 100 kPa·sec or more and 1,000 kPa·sec or less.
C: Complex viscosity is more than 1,000 kPa·sec.

### 4.2.2. Evaluation of Appearance and Color Toning Properties

In the evaluation samples according to each Example and each Comparative Example obtained above, the L* value was measured using a fluorescence spectrophotometer (FD-7, Konica Minolta Inc.) and determined according to the following criteria.

### Determination Criteria

A: L* of 70 or more
B: L* of less than 70

### 4.2.3. Evaluation of Charpy Impact Strength

In the evaluation samples according to each Example and each Comparative Example obtained above, the shape of the test piece was a rectangular plate shape having a long side of 80 mm±2 mm, a short side of 4.0 mm±0.2 mm, and a thickness of 10.0 mm±0.2 mm, and the Charpy impact strength was measured in accordance with ISO 179 (JIS K 7111) using an “impact tester IT” manufactured by Toyo Seiki Seisaku-sho, Ltd. as a testing apparatus, with a hammer weight of 4 J (WR 2.14 N/m), a lifting angle of 150°, a notch remaining width of 8.0 mm±0.2 mm, and a notch angle of 45°.

### 4.2.4. Determination

The above evaluation was determined based on the following criteria, and the molding material of each example was evaluated.
A: Both injection moldability and appearance and color toning properties are A, and Charpy impact strength is 4 kJ/m² or more.
B: Both injection moldability and appearance and color toning properties are A, and Charpy impact strength is less than 4 kJ/m².
C: Appearance and color toning properties are B.
D: Not kneadable.

### 4.3. Evaluation of Result

It was found that the molding materials of each Example, each of which is a molding material including cellulose, polylactic acid, and a biodegradable polyester other than the polylactic acid, in which the cellulose includes a first cellulose having a peak top in a particle diameter region of 3 μm or more and 100 μm or less in a volume-based particle size distribution curve, and a second cellulose having a peak top in a particle diameter region of 50 μm or more and 500 μm or less in a volume-based particle size distribution curve, and a particle diameter of the first cellulose at the peak top is smaller than a particle diameter of the second cellulose at the peak top, had favorable color toning properties, and the comprehensive evaluation was also favorable.

The above-described embodiments are examples, and the present disclosure is not limited to thereto. For example, each embodiment and each modification example can be combined as appropriate.

The present disclosure includes a configuration substantially the same as the configuration described in the embodiment, for example, a configuration having the same function, method, and result, or a configuration having the same purpose and effect. Further, the present disclosure includes configurations in which non-essential parts of the configuration described in the embodiments are replaced. In addition, the present disclosure includes configurations that achieve the same effects or configurations that can achieve the same objects as those of the configurations described in the embodiment. Further, the present disclosure includes configurations in which a known technology is added to the configurations described in the embodiments.

The following contents are derived from the above-described embodiments and modification examples.

A molding material including:
a biodegradable resin; and
cellulose, in which
the biodegradable resin includes polylactic acid and a biodegradable polyester other than the polylactic acid,
the cellulose includes a first cellulose having a peak top in a particle diameter region of 3 μm or more and 100 μm or less in a volume-based particle size distribution curve, and a second cellulose having a peak top in a particle diameter region of 50 μm or more and 500 μm or less in a volume-based particle size distribution curve, and
a particle diameter of the first cellulose at the peak top is smaller than a particle diameter of the second cellulose at the peak top.

According to the molding material, heat generation during kneading is suppressed by including the first cellulose and the second cellulose, and a molded article having excellent color toning properties can be obtained.

In the above molding material,
the complex viscosity may be 600 Pa·s or more and 80,000 Pa·s or less.

According to the molding material, heat generation during kneading is further suppressed, and a molded article can be obtained with favorable moldability.

The molding material may further include a filler.

According to the molding material, a molded article having more favorable impact resistance can be obtained.

In the molding material,
a content of the biodegradable resin may be 50% by mass or less with respect to a total amount of the material.

According to the molding material, heat generation during kneading is suppressed by including the first cellulose and the second cellulose and thus the effect that a molded article having excellent color toning properties can be obtained is more remarkably obtained.

In the above molding material,
the particle diameter of the first cellulose at the peak top may be 5% or more and 40% or less of the particle diameter of the second cellulose at the peak top.

According to the molding material, heat generation during kneading is suppressed and thus the effect that a molded article having excellent color toning properties can be obtained is more remarkably obtained.

In the molding material,
a content of the cellulose may be 60% by mass or more.

According to the molding material, heat generation during kneading is suppressed and thus the effect that a molded article having excellent color toning properties can be obtained is more remarkably obtained.

A molded article molded by using the molding material.

In the molded article, the molded article may be a container or a tableware.

What is claimed is:

1. A molding material comprising:
a resin; and
cellulose, wherein
the resin includes an aliphatic polyester and a polyester-based elastomer,
the cellulose includes a first cellulose having a peak top in a particle diameter region of 3 μm or more and 100 μm or less in a volume-based particle size distribution curve, and a second cellulose having a peak top in a particle diameter region of 50 μm or more and 500 μm or less in a volume-based particle size distribution curve, and
a particle diameter of the first cellulose at the peak top is smaller than a particle diameter of the second cellulose at the peak top.

2. The molding material according to claim 1, wherein
a complex viscosity is 600 Pa·s or more and 80,000 Pa·s or less.

3. The molding material according to claim 1, further comprising:
a filler.

4. The molding material according to claim 1, wherein
a content of the resin is 50% by mass or less with respect to a total amount of the material.

5. The molding material according to claim 1, wherein
the particle diameter of the first cellulose at the peak top is 5% or more and 40% or less of the particle diameter of the second cellulose at the peak top.

6. The molding material according to claim 1, wherein
a content of the cellulose is 60% by mass or more.

7. A molding material comprising:
a biodegradable resin; and
cellulose, wherein
the biodegradable resin includes polylactic acid and a biodegradable polyester other than the polylactic acid,
the cellulose includes a first cellulose having a peak top in a particle diameter region of 3 μm or more and 100 μm or less in a volume-based particle size distribution curve, and a second cellulose having a peak top in a particle diameter region of 50 μm or more and 500 μm or less in a volume-based particle size distribution curve, and
a particle diameter of the first cellulose at the peak top is smaller than a particle diameter of the second cellulose at the peak top.

8. The molding material according to claim 7, wherein
a complex viscosity is 600 Pa·s or more and 80,000 Pa·s or less.

9. The molding material according to claim 7, further comprising:
a filler.

10. The molding material according to claim 7, wherein
a content of the biodegradable resin is 50% by mass or less with respect to a total amount of the material.

11. The molding material according to claim 7, wherein
the particle diameter of the first cellulose at the peak top is 5% or more and 40% or less of the particle diameter of the second cellulose at the peak top.

12. The molding material according to claim 7, wherein
a content of the cellulose is 60% by mass or more.

13. A molded article molded by using the molding material according to claim 7.

14. The molded article according to claim 13, wherein
the molded article is a container or a tableware.
